(19) United States
(12) Patent Application Publication
(10) Pub. No.: US 2025/0053447 A1
(43) Pub. Date: Feb. 13, 2025

(54) WORK MANAGEMENT DEVICE, WORK MANAGEMENT METHOD, AND COMPUTER READABLE MEDIUM

(71) Applicant: Mitsubishi Electric Corporation, Tokyo (JP)

(72) Inventors: Gosuke MINAMI, Tokyo (JP); Kazuki WATANABE, Tokyo (JP)

(73) Assignee: Mitsubishi Electric Corporation, Tokyo (JP)

(21) Appl. No.: 18/933,415

(22) Filed: Oct. 31, 2024

Related U.S. Application Data
(63) Continuation of application No. PCT/JP2022/020830, filed on May 19, 2022.

(51) Int. Cl. G06F 9/48; G06F 9/54

(52) U.S. Cl. CPC G06F 9/4887; G06F 9/542

(57) ABSTRACT

A progress acceptance unit (214) accepts delay information that indicates a delay task, which is a task in which a delay may occur. An impact identification unit (23) refers to allocation relation information that indicates resources respectively allocated to a plurality of tasks so as to identify a task that is allocated the same resource as a resource allocated to the delay task indicated by the delay information accepted by the progress acceptance unit (214) as an affected task that may be affected by a delay in the delay task. A notification unit (24) notifies a person in charge of the affected task identified by the impact identification unit (23).

### CROSS REFERENCE TO RELATED APPLICATIONS

This application is a Continuation of PCT International Application No. PCT/JP2022/020830 filed on May 19, 2022, all of which is hereby expressly incorporated by reference into the present application.

### TECHNICAL FIELD

The present disclosure relates to a technology to assist schedule management of tasks.

### BACKGROUND ART

For example, in medical institutions such as hospitals, treatment schedules are created for patients individually according to their illnesses. A treatment schedule is a list of daily work items for each patient. However, in order to actually carry out work, it is necessary to allocate time, a staff member, equipment, and a place for carrying out the work for each work item.

Patent Literature 1 describes creating a list of work items required for each patient and a list of resources required for carrying out the work items. Patent Literature 1 describes allocating resources to each work item of each patient by referring to the two lists.

### CITATION LIST

### Patent Literature

Patent Literature 1: JP 2016-099766 A

### SUMMARY OF INVENTION

### Technical Problem

There may be a case where there are a plurality of persons in charge of allocating resources to tasks. In this case, with the technology described in Patent Literature 1, each person in charge cannot know how other persons in charge allocate resources to tasks and states of progress of tasks of other persons in charge. Therefore, if a delay occurs in a task in charge of another person, each person in charge cannot know the impact on his or her own task.

An object of the present disclosure is to make it possible, when a delay may occur in a task, to identify an impact of the delay.

### Solution to Problem

A work management device according to the present disclosure includes
a progress acceptance unit to accept delay information that indicates a delay task, the delay task being a task in which a delay may occur; and
an impact identification unit to refer to allocation relation information that indicates resources respectively allocated to a plurality of tasks so as to identify a task that is allocated a same resource as a resource allocated to the delay task indicated by the delay information accepted by the progress acceptance unit as an affected task that may be affected by a delay in the delay task.

### Advantageous Effects of Invention

In the present disclosure, a task that is allocated the same resource as a resource allocated to a delay task is identified. This makes it possible to know a task that may be affected by a delay in the delay task.

### BRIEF DESCRIPTION OF DRAWINGS

FIG. 1 is a configuration diagram of a work management system 100 according to Embodiment 1;

FIG. 2 is a configuration diagram of the work management device 10 according to Embodiment 1;

FIG. 3 is a flowchart of a data collection process according to Embodiment 1;

FIG. 4 is a figure describing resource information 31 according to Embodiment 1;

FIG. 5 is a figure describing task information 32 according to Embodiment 1;

FIG. 6 is a figure describing allocation information 33 according to Embodiment 1;

FIG. 7 is a figure describing allocation relation information 34 according to Embodiment 1;

FIG. 8 is a figure describing dependence relation information 35 according to Embodiment 1;

FIG. 9 is a flowchart of an affected task identification process according to Embodiment 1; and

FIG. 10 is a configuration diagram of the work management device 10 according to Variation 1.

### DESCRIPTION OF EMBODIMENTS

### Embodiment 1

### *** Description of Configuration ***

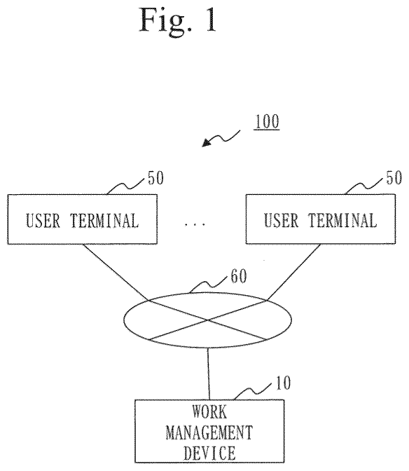

Referring to FIG. 1, a configuration of a work management system 100 according to Embodiment 1 will be described.

The work management system 100 includes a work management device 10 and one or more user terminals 50. The work management device 10 and each of the one or more user terminals 50 are connected via a network 60.

The work management device 10 is a computer, such as a server, that identifies another task that may be affected by a task in which a delay has occurred. The user terminal 50 is a computer, such as a PC, that is used by a person in charge of managing tasks. PC is an abbreviation for personal computer. The network 60 is a communication facility to connect the work management device 10 and the user terminal 50 by wire or wirelessly and transmit information. The network 60 is composed of communication lines and a communication device.

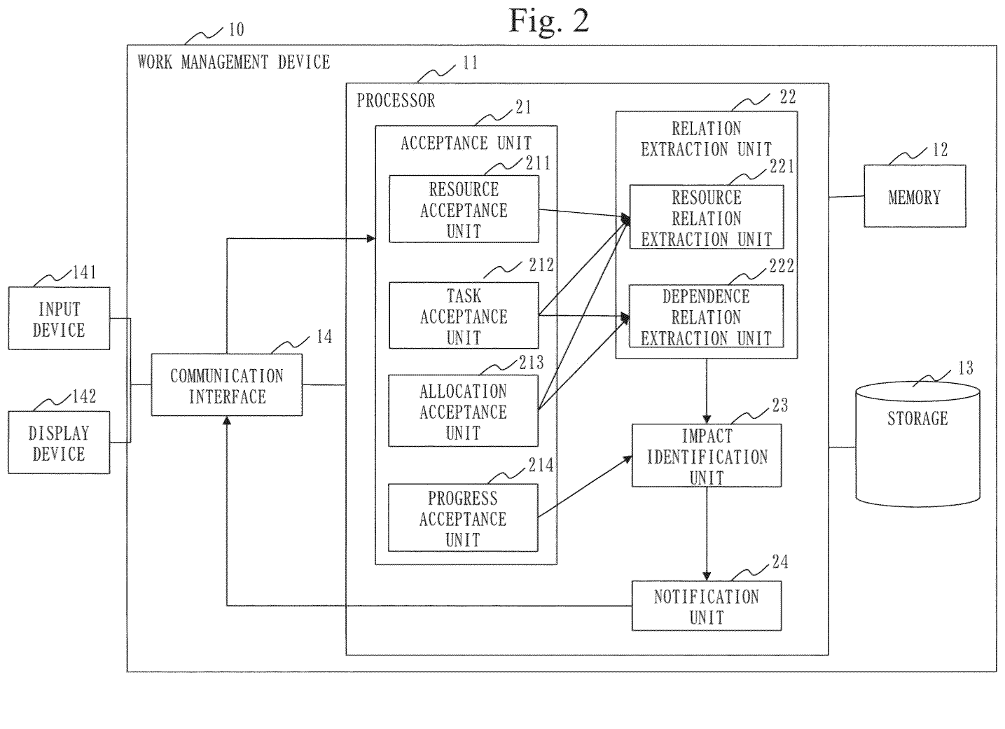

Referring to FIG. 2, a configuration of the work management device 10 according to Embodiment 1 will be described.

The work management device 10 includes hardware of a processor 11, a memory 12, a storage 13, and a communication interface 14. The processor 11 is connected with other hardware components through signal lines and controls these other hardware components.

The processor 11 is an IC that performs processing. IC is an abbreviation for integrated circuit. Specific examples of the processor 11 are a CPU, a DSP, and a GPU. CPU is an abbreviation for central processing unit. DSP is an abbreviation for digital signal processor. GPU is an abbreviation for graphics processing unit.

The memory 12 is a storage device to temporarily store data. Specific examples of the memory 12 are an SRAM and a DRAM. SRAM is an abbreviation for static random access memory. DRAM is an abbreviation for dynamic random access memory.

The storage 13 is a storage device to store data. A specific example of the storage 13 is an HDD. HDD is an abbreviation for hard disk drive. Alternatively, the storage 13 may be a portable recording medium such as an SD (registered trademark) memory card, CompactFlash (registered trademark), a NAND flash, a flexible disk, an optical disc, a compact disc, a Blu-ray (registered trademark) disc, or a DVD. SD is an abbreviation for Secure Digital. DVD is an abbreviation for digital versatile disk.

The communication interface 14 is an interface for establishing communication with other devices and transmitting and receiving data. Specific examples of the communication interface 14 are an Ethernet (registered trademark) port, a USB port, and an HDMI (registered trademark) port. USB is an abbreviation for Universal Serial Bus. HDMI is an abbreviation for High-Definition Multimedia Interface.

The work management device 10 is connected with an input device 141 and a display device 142 via the communication interface 14. A specific example of the input device 141 is a keyboard and a mouse. A specific example of the display device 142 is an LCD. LCD is an abbreviation for liquid crystal display.

The work management device 10 includes, as functional components, an acceptance unit 21, a relation extraction unit 22, an impact identification unit 23, and a notification unit 24. The acceptance unit 21 includes a resource acceptance unit 211, a task acceptance unit 212, an allocation acceptance unit 213, and a progress acceptance unit 214. The relation extraction unit 22 includes a resource relation extraction unit 221 and a dependence relation extraction unit 222. The functions of the functional components of the work management device 10 are realized by software.

The storage 13 stores programs that realize the functions of the functional components of the work management device 10. These programs are read into the memory 12 by the processor 11 and executed by the processor 11. This realizes the functions of the functional components of the work management device 10.

In FIG. 2, only one processor 11 is illustrated. However, there may be a plurality of processors 11, and the plurality of processors 11 may cooperate to execute the programs that realize the functions.

### *** Description of Operation ***

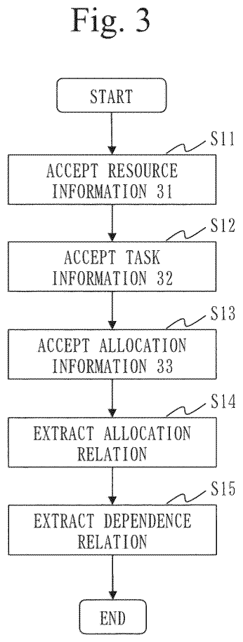

Referring to FIGS. 3 to 9, operation of the work management device 10 according to Embodiment 1 will be described.

A procedure for the operation of the work management device 10 according to Embodiment 1 is equivalent to a work management method according to Embodiment 1. A program that realizes the operation of the work management device 10 according to Embodiment 1 is equivalent to a work management program according to Embodiment 1.

The operation of the work management device 10 includes a data collection process and an affected task identification process.

Referring to FIG. 3, the data collection process according to Embodiment 1 will be described.

### (Step S11: Resource Acceptance Process)

The resource acceptance unit 211 accepts input of resource information 31.

Specifically, the resource acceptance unit 211 accepts the resource information 31 input by one of the user terminals 50. Alternatively, the resource acceptance unit 211 may accept the resource information 31 input by operating the input device 141. The resource acceptance unit 211 writes the accepted resource information 31 to the storage 13.

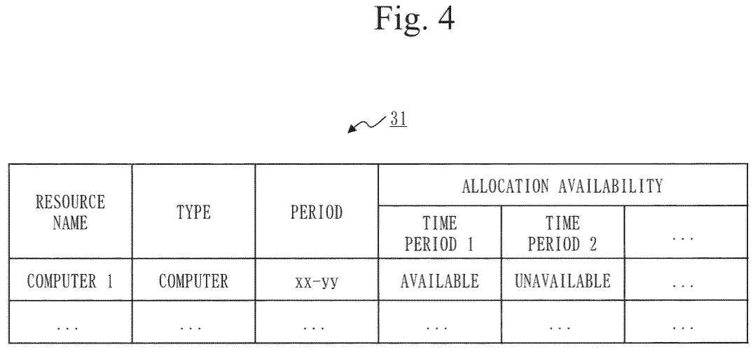

As indicated in FIG. 4, the resource information 31 is information about resources. The resource information 31 includes information such as a resource name, a type, a period, and allocation availability. The resource name is information that allows a resource to be identified. The type is a classification of the resource. The period is a period during which allocation to a task is allowed. The allocation availability indicates whether allocation to a task is possible. The allocation availability is set on a per time period basis, for example.

### (Step S12: Task Acceptance Process)

The task acceptance unit 212 accepts input of task information 32.

Specifically, the task acceptance unit 212 accepts the task information 32 input by one of the user terminals 50. Alternatively, the task acceptance unit 212 may accept the task information 32 input by operating the input device 141. The task acceptance unit 212 writes the accepted task information 32 to the storage 13.

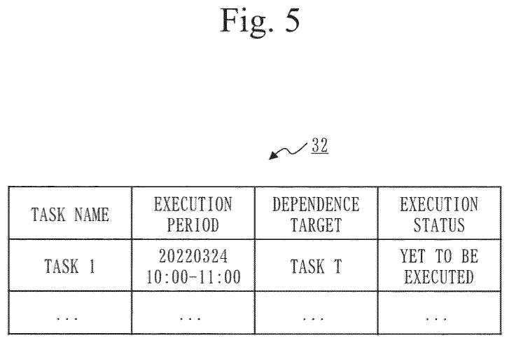

As indicated in FIG. 5, the task information 32 is information about tasks. The task information 32 includes information such as a task name, an execution period, a dependence target, and an execution status. The task name is information that allows a task to be identified. The execution period is a period during which the task is scheduled to be executed. The dependence target is another task that needs to be completed in order for the task to be executed. The execution status is an execution status of the task.

### (Step S13: Allocation Acceptance Process)

The allocation acceptance unit 213 accepts allocation information 33 of allocation of resources to tasks.

Specifically, the allocation acceptance unit 213 accepts the allocation information 33 input by one of the user terminals 50. Alternatively, the allocation acceptance unit 213 may accept the allocation information 33 input by operating the input device 141. At this time, the allocation acceptance unit 213 may display the resource information 31 and the task information 32 on the display device 142. The allocation acceptance unit 213 writes the accepted allocation information 33 to the storage 13. For example, a person in charge is assigned to each of a plurality of tasks. For each of the tasks, the allocation information 33 is input by the person in charge of that task.

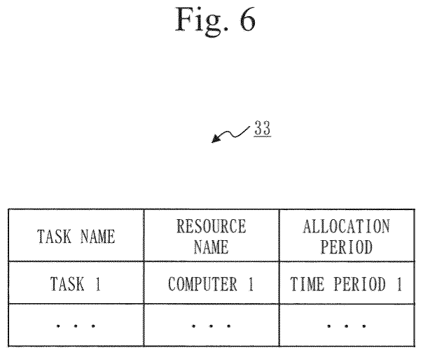

As indicated in FIG. 6, the allocation information 33 is information that indicates resources allocated to tasks individually. The allocation information 33 includes information such as a task name, a resource name, and an allocation period. The allocation period indicates a period during which the resource indicated by the resource name is allocated to the task indicated by the task name.

### (Step S14: Resource Relation Extraction Process)

The resource relation extraction unit 221 extracts an allocation relation between a task and a resource allocated to the task. Then, the resource relation extraction unit 221 generates allocation relation information 34 that indicates the allocation relation. The resource relation extraction unit 221 writes the allocation relation information 34 to the storage 13.

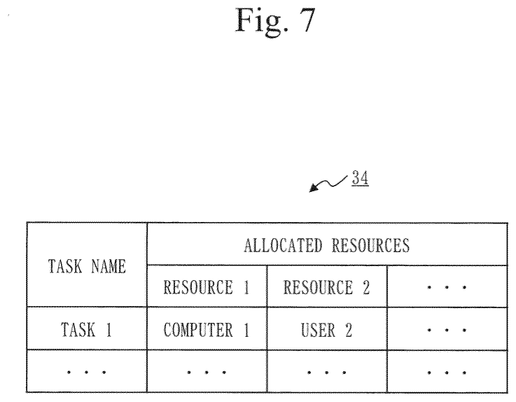

Specifically, the resource relation extraction unit 221 refers to the allocation information 33 accepted in step S13 to extract each resource allocated to each task. As a result, the allocation relation information 34 indicating the resource name of each allocated resource for each task name is generated, as indicated in FIG. 7.

### (Step S15: Dependence Relation Extraction Process)

The dependence relation extraction unit 222 extracts dependence relations between tasks. Then, the dependence relation extraction unit 222 generates dependence relation information 35 indicating the dependence relations. The dependence relation extraction unit 222 writes the dependence relation information 35 to the storage 13. A dependence relation indicates that there is a task Y that needs to be completed in order for a task X to be executed. The task X is called a dependence origin task, and the task Y is called a dependence target task.

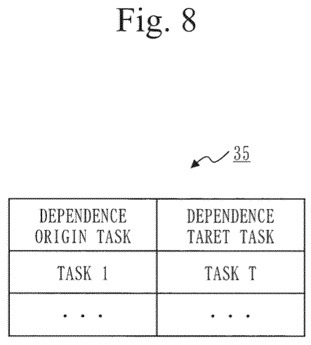

Specifically, the dependence relation extraction unit 222 refers to the dependence target task in the task information 32 accepted in step S12 to extract a dependence relation. The dependence relation extraction unit 222 extracts a task indicated by the task name in the task information 32 as a dependence origin task, and extracts a task indicated by the dependence target as a dependence target task. As a result, the dependence relation information 35 indicating the dependence origin task and the dependence target task is generated, as indicated in FIG. 8.

A dependence relation does not have to be one-to-one. There may be a plurality of dependence target tasks for one dependence origin task. There may be a plurality of dependence origin tasks for one dependence target task.

In step S13, the allocation acceptance unit 213 may update the allocation availability in the resource information 31 for the resource indicated by the resource name to allocation unavailable for the allocation period. This prevents the same resource to be allocated to a plurality of tasks in overlapping periods.

Alternatively, if the same resource is allocated to a plurality of tasks in overlapping periods in step S13, the notification unit 24 may notify the user terminals 50 used by the persons in change of these tasks. This can help a resource conflict to be resolved. If the same resource is allocated to a plurality of tasks in close periods even if the periods do not overlap, the notification unit 24 may notify the user terminals 50 used by the persons in charge of these tasks. This makes it possible to know in advance that a resource conflict will occur if a delay occurs in the execution of a certain task.

The work management device 10 may allow the resource information 31, the task information 32, the allocation information 33, the allocation relation information 34, and the dependence relation information 35 to be referred to from the user terminal 50. Alternatively, the work management device 10 may display the resource information 31, the task information 32, the allocation information 33, the allocation relation information 34, and the dependence relation information 35 on the display device 142 upon request.

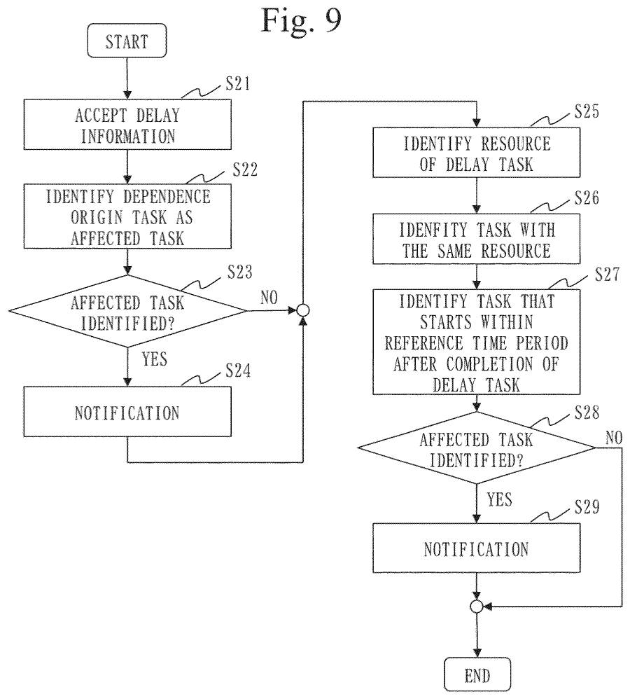

Referring to FIG. 9, the affected task identification process according to Embodiment 1 will be described.

### (Step S21: Progress Acceptance Process)

The progress acceptance unit 214 accepts input of progress information of a task. Here, as the progress information, the progress acceptance unit 214 accepts delay information indicating a delay task, which is a task in which a delay may occur. Specifically, the progress acceptance unit 214 accept the delay information input by one of the user terminals 50. Alternatively, the progress acceptance unit 214 may accept the delay information input by operating the input device 141. For example, the delay information is input by the person in charge of the delay task.

### (Step S22: Dependent Task Identification Process)

The impact identification unit 23 identifies a dependence origin task whose dependence target task is the delay task indicated by the delay information accepted in step S21 as an affected task that may be affected by a delay in the delay task.

Specifically, the impact identification unit 23 identifies a record in which the delay task is set as the dependence target task in the dependence relation information 35. The impact identification unit 23 identifies the dependence origin task in the identified record as the affected task.

### (Step S23: First Existence Determination Process)

The impact identification unit 23 identifies whether an affected task has been identified in step S22.

If an affected task has been identified, the impact identification unit 23 advances processing to step S24. If no affected task has been identified, the impact identification unit 23 skips step S24 and advances processing to step S25.

### (Step S24: First Notification Process)

The notification unit 24 notifies the person in charge of the affected task identified in step S22.

Specifically, the notification unit 24 sends a message including the task name of the affected task to the user terminal 50 used by the person in charge of the affected task. The notification unit 24 may display the task name and so on of the affected task on the display device 142. At this time, the notification unit 24 may also notify information about the delay task. The information about the delay task is information such as an execution period, allocated resources, and an execution status of the delay task. The execution status is a progress rate, a delay situation or a possibility of occurrence of a delay, and so on.

### (Step S25: Resource Identification Process)

The impact identification unit 23 identifies a resource allocated to the delay task indicated by the delay information accepted in step S21.

Specifically, the impact identification unit 23 identifies a record in which the task name of the delay task is set from the allocation relation information 34. The impact identification unit 23 identifies the resource name of the resource set in the extracted record.

### (Step S26: Same-allocation Task Identification Process)

The impact identification unit 23 identifies a task that is allocated the same resource as the resource identified in step S25.

Specifically, the impact identification unit 23 identifies records in which the resource name identified in step S25 is set from the allocation relation information 34. The impact identification unit 23 identifies a task name of each record other than the record of the delay task among the identified records.

### (Step S27: Execution Period Identification Process)

The impact identification unit 23 identifies, among the tasks identified in step S26, a task that is scheduled to start within a reference time period after completion of the execution of the delay task as an affected task that may be affected by a delay in the delay task.

Specifically, the impact identification unit 23 identifies the record in which the task name of the delay task is set from the task information 32. The impact identification unit 23 identifies the end date and time of the execution period set in the extracted record. The impact identification unit 23 identifies the record with the task name identified in step S26 from the task information 32. The impact identification unit 23 identifies the start date and time of the execution period set in the identified record. The impact identification unit 23 determines whether the identified start date and time is within the reference time period after the identified end date and time. If the start date and time is within the reference time period after the identified end time, the impact identification unit 23 identifies the task indicated by the task name as the affected task.

### (Step S28: Second Existence Determination Process)

The impact identification unit 23 determines whether an affected task has been identified in step S27.

If an affected task has been identified, the impact identification unit 23 advances processing to step S29. If no affected task has been identified, the impact identification unit 23 skips step S29 and terminates processing.

### (Step S29: Second Notification Process)

The notification unit 24 notifies the person in charge of the affected task identified in step S27

Specifically, the notification unit 24 sends a message including the task name of the affected task to the user terminal 50 allocated to the person in charge of the affected task. The notification unit 24 may display the task name and so on of the affected task on the display device 142. At this time, the notification unit 24 may also notify information about the delay task, as in step S24.

The notification unit 24 may change the notification content between step S24 and step S29. For example, in step S24, the notification unit 24 notifies that a delay may occur in the dependence origin task. In step S29, the notification unit 24 notifies that a delay may occur in a task with which there is a resource conflict.

### *** Effects of Embodiment 1 ***

As described above, the work management device 10 according to Embodiment 1 identifies, as an affected task, a task that is allocated the same resource as a resource allocated to a delay task. This makes it possible to identify a task that may be affected by a delay in the delay task due to a resource conflict.

If a delay in the delay task may cause an impact due to a resource conflict, possible countermeasures include changing the allocated resource and changing the execution period of the task. This can prevent a delay in the affected task due to a delay in the delay task.

The work management device 10 according to Embodiment 1 identifies, as an affected task, a task that starts within a reference time period after completion of a delay task. This makes it possible to identify only a task that is likely to be affected among tasks that are allocated the same resource.

The work management device 10 according to Embodiment 1 identifies, as an affected task, a task that is dependent on a delay task. This makes it possible to identify a task that may be affected by a delay in the delay task due to dependence between the tasks.

If a delay in the delay task may cause an impact due to dependence between the tasks, possible countermeasures include changing the execution period of the task. This can prevent a delay also in the affected task due to a delay in the delay task.

The work management device 10 according to Embodiment 1 prevents the same resource from being allocated to a plurality of tasks in the same period. This can prevent a wait state due to a resource conflict.

The work management device 10 according to Embodiment 1 allows the resource information 31, the task information 32, the allocation information 33, the allocation relation information 34, and the dependence relation information 35 to be referred to from the user terminal 50 or the like. When a plurality of managers manage tasks, this makes it possible for each of the managers to know individual schedules for the tasks and resources allocated individually to the tasks.

The work management device 10 according to Embodiment 1 is suitable for a use case where one or more project managers perform process management in a situation where resources such as persons, computers, and places for executing a plurality of tasks are required. In particular, the work management device 10 according to Embodiment 1 is suitable for being applied to a use case where a plurality of project managers perform process management. A project manager is a person in charge of managing the progress of a project.

For example, in a testing process in system development, it is common for a plurality of persons in charge of testing to separately manage each test item and human and computer resources for executing each test item. The work management device 10 according to Embodiment 1 is applied to the testing process in system development.

In a situation where a plurality of persons in charge of testing use common resources to proceed with testing, a risk of occurrence of a delay may arise in a task managed by a different person in charge. In this case, it is notified from the work management device 10 that a task managed by the notified person in charge may be affected by the delay. This allows the person in charge to know the impact on the task managed by the person in charge before the impact occurs. In addition, if the work management device 10 is also configured to notify information about the task in which a risk of occurrence of a delay has arisen, this facilitates the person in charge to know the extent of the impact.

### *** Other Configurations ***

### <Variation 1>

In Embodiment 1, the functional components are realized by software. However, as Variation 1, the functional components may be realized by hardware. With regard to this Variation 1, differences from Embodiment 1 will be described.

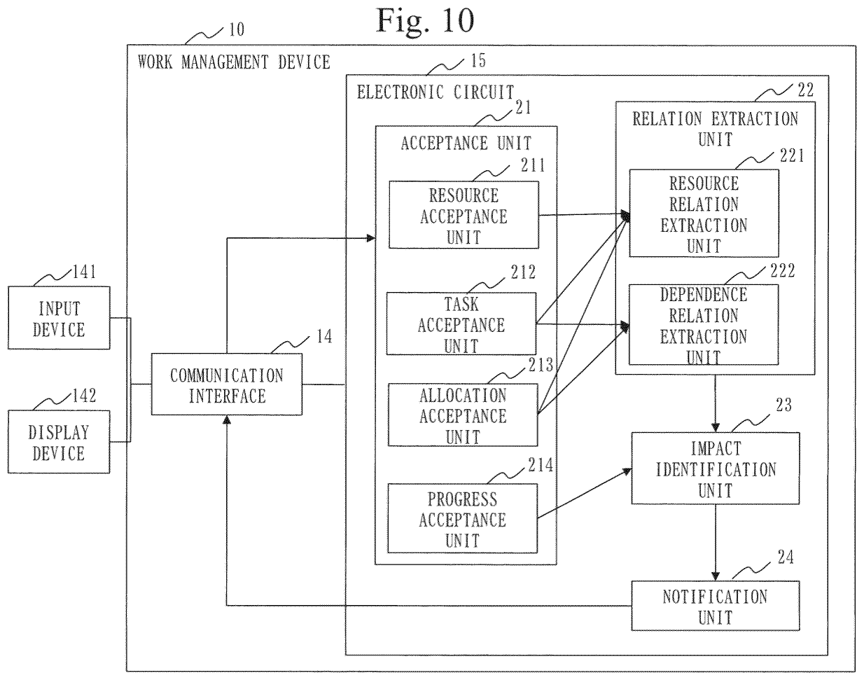

Referring to FIG. 10, a configuration of the work management device 10 according to Variation 1 will be described.

When the functional components are realized by hardware, the work management device 10 includes an electronic circuit 15 in place of the processor 11, the memory 12, and the storage 13. The electronic circuit 15 is a dedicated circuit that realizes the functions of the functional components, the memory 12, and the storage 13.

The electronic circuit 15 is assumed to be a single circuit, a composite circuit, a programmed processor, a parallel-programmed processor, a logic IC, a GA, an ASIC, or an FPGA. GA is an abbreviation for gate array. ASIC is an abbreviation for application specific integrated circuit. FPGA is an abbreviation for field-programmable programmable gate array.

The functional components may be realized by one electronic circuit 15, or the functional components may be distributed to and realized by a plurality of electronic circuits 15.

### <Variation 2>

As Variation 2, some of the functional components may be realized by hardware, and the rest of the functional components may be realized by software.

Each of the processor 11, the memory 12, the storage 13, and the electronic circuit 15 is referred to as processing circuitry. That is, the functions of the functional components are realized by the processing circuitry.

“Unit” in the above description may be interpreted as “circuit”, “step”, “procedure”, “process”, or “processing circuitry”.

The embodiment and variations of the present disclosure have been described above. Two or more of these embodiment and variations may be implemented in combination. Alternatively, one of them or two or more of them may be partially implemented. The present disclosure is not limited to the above embodiment and variations, and various modifications can be made as necessary.

### REFERENCE SIGNS LIST

100: work management system, 10: work management device, 11: processor, 12: memory, 13: storage, 14: communication interface, 141: input device, 142: display device, 21: acceptance unit, 22: relation extraction unit, 23: impact identification unit, 24: notification unit, 211: resource acceptance unit, 212: task acceptance unit, 213: allocation acceptance unit, 214: progress acceptance unit, 221: resource relation extraction unit, 222: dependence relation extraction unit, 31: resource information, 32: task information, 33: allocation information, 34: allocation relation information, 35: dependence relation information, 50: user terminal, 60: network.

1. A work management device comprising
processing circuitry to:
accept delay information that indicates a delay task, the delay task being a task in which a delay may occur;
refer to allocation relation information that indicates resources respectively allocated to a plurality of tasks so as to identify a task that is allocated a same resource as a resource allocated to the delay task indicated by the accepted delay information as an affected task that may be affected by a delay in the delay task, and refer to dependence relation information that indicates a dependence relation between tasks so as to identify, as the affected task, a task whose requirement for execution is completion of the delay task; and
notify a person in charge of the affected task by displaying information about the affected task and also information about the delay task.

2. The work management device according to claim 1,
wherein the processing circuitry identifies, as the affected task, a task that is scheduled to start within a reference time period after completion of execution of the delay task among tasks that are allocated the same resource as the resource allocated to the delay task.

3. A work management method comprising:
accepting delay information that indicates a delay task, the delay task being a task in which a delay may occur;
referring to allocation relation information that indicates resources respectively allocated to a plurality of tasks so as to identify a task that is allocated a same resource as a resource allocated to the delay task indicated by the delay information as an affected task that may be affected by a delay in the delay task, and referring to dependence relation information that indicates a dependence relation between tasks so as to identify, as the affected task, a task whose requirement for execution is completion of the delay task; and
notifying a person in charge of the affected task by displaying information about the affected task and also information about the delay task.

4. A non-transitory computer readable medium storing a work management program that causes a computer to function as a work management device to perform:
a progress acceptance process of accepting delay information that indicates a delay task, the delay task being a task in which a delay may occur;
an impact identification process of referring to allocation relation information that indicates resources respectively allocated to a plurality of tasks so as to identify a task that is allocated a same resource as a resource allocated to the delay task indicated by the delay information accepted by the progress acceptance process as an affected task that may be affected by a delay in the delay task, and referring to dependence relation information that indicates a dependence relation between tasks so as to identify, as the affected task, a task whose requirement for execution is completion of the delay task; and
a notification process of notifying a person in charge of the affected task by displaying information about the affected task identified by the impact identification process and also information about the delay task.
